(19) United States
(12) Patent Application Publication
(10) Pub. No.: US 2012/0117835 A1
(43) Pub. Date: May 17, 2012

(54) SAND-FLOWING PICTURE DEVICE

(76) Inventor: CHENG-HSIUNG LIN, Taipei City (TW)

(21) Appl. No.: 13/354,978

(22) Filed: Jan. 20, 2012

Related U.S. Application Data
(63) Continuation-in-part of application No. 12/692,899, filed on Jan. 25, 2010.

(51) Int. Cl. G09F 19/02

(52) U.S. Cl. 40/409

(57) ABSTRACT

A sand-flowing picture device includes a transparent, flat and sealed container, a fluid, first sand particulates with a specific gravity higher than the fluid and second sand particulates with a specific gravity lower than the fluid. The second sand particulates with a predetermined quantity fewer than the first sand particulates so as to provide slots which the first sand particulates can pass through gradually downwardly when the first sand particulates fall on and along a layer formed by the second sand particulates that rise upon inversion of the container in a vertical position. The container is substantially bubble-free. Therefore, the device can show a sand picture of dynamic variation and form a new and different decorative pattern.

### CROSS REFERENCE TO RELATED APPLICATION

This application is a continuation-in-part of U.S. application Ser. No. 12/692,899, filed on Jan. 25, 2010 and entitled “flowing sand picture”, now pending, the entire disclosures of which are incorporated herein by reference.

### FIELD OF THE INVENTION

The present invention relates to a sand picture and more particularly, to a sand-flowing picture device, which may have sand particulates of different specific gravities with a liquid filled inside a transparent, flat and sealed container which is substantially bubble-free to show a picture of dynamic variation when the container is turned upside down.

### BACKGROUND OF THE INVENTION

Sand picture is a kind of art for pouring colored sands, powdered pigments from minerals or crystals, and pigments from other natural or synthetic sources onto a surface to make a fixed or unfixed sand painting. Also, the sand picture can be formed by a sand-flowing picture device that may have a pictorial and may be used as visual display medium, or as a toy or amusement device, or for advertising or other purpose.

As shown in Smithies U.S. Pat. No. 4,686,784, a conventional sand-flowing picture device includes a sealed flat container formed by two rectangular sheets of glass spaced from each other and sealed together via a glue layer at their outer edges. The container encloses water and detergent, a quantity of air and fine sands. After settling of the sand in one direction, the container is inverted causing bobbles of the air to rise and form a bubble layer partially supporting the sand while allowing it to percolate gradually downwardly between the bubbles.

FIG. 1 illustrates a sand-flowing picture device according to the U.S. Pat. No. 4,686,784. In this design, the device includes a transparent flat container 1 having sealed therein a liquid 11 (water or oil) and a particulate material 12 (for example, sand) that has a specific gravity higher than the liquid 11. When the container 1 is turned upside down, the particulate material 12 flows down in the liquid 11 rapidly and bubbles 13 are produced to flow upwards in the liquid 11. The upwardly flowing bubbles 13 slow down the downward flowing speed of the particulate material 12. Thus, a variation of sand-flowing picture may be seen.

In this kind of sand-flowing picture device, the bubbles 13 can be utilized for partially stopping the sand to delay its fallen speed, thereby to produce a multi-layer pattern as the better effect for the sand-flowing picture from a visual appeal. However, the bubbles may gradually decrease and then disappear within a very short time (about 6 months) due to reason such as; the two glass sheets may experience thermal contraction to force air out of the container. On the other hand, the bubbles may gradually increase due to reason such as; the liquid may evaporate through small seams or cracks of the container so as to increase the volume of air inside the container. Therefore, when the bubbles disappear or a great quantity of air enters the container, the multi-layer picture or pattern will also disappear subsequently.

In addition, the liquid may be formed to a large number of bubbles with irregular sizes or a few of bubbles with large sizes upon inversion of the container. Therefore, the U.S. Pat. No. 4,686,784 discloses the liquid still needs to contain a bubble producing substance, such as detergent, for producing a large number of bubbles with small sizes when the container is agitated to enhance the effect of the device. Also, the bubbles each have a size far larger than sand particulates; therefore, the scene in which bubbles are mixed with the sand is not attractive, so as to decrease aesthetic feeling when viewing the container during a sand-flowing process.

Peiperl U.S. Pat. No. 5,172,270 discloses a kaleidoscope utilizing birefringent material in a liquid in a unit which can be inverted or rotated located between sheets of polarizing. The U.S. Pat. No. 5,172,270 also discloses the pieces of the birefringent material (rather than sand particulates) may be of a heavier or lower density than liquid, or may be a mixture of both densities and rise and fall in the container. In addition, as stated in the U.S. Pat. No. 5,172,270, an air expansion bubble is left in the tube to provide for expansion of the liquid in case the temperature of the tube is raised. However, the U.S. Pat. No. 5,172,270 fails to suggest and teach that the birefringent material may be applied on a field of the sand-flowing picture or combined with the U.S. Pat. No. 4,686,784 for producing the visual appeal as a sand-flowing or sandglass effect.

Hence, it is desirable to have a sand-flowing picture device to overcome the above-mentioned disadvantages of the prior art.

### SUMMARY OF THE INVENTION

It is an object of the present invention to present a sand-flowing picture device with sand particulates of different specific gravities capable of showing a sand picture of dynamic variation and forming a new and different decorative pattern without bubbles.

The present invention has been accomplished under the circumstances in view. The present invention provides a sand-flowing picture device including a transparent, flat and sealed container, a fluid, a great quantity of first sand particulates and a small quantity of second sand particulates. The container has a chamber formed therein. The fluid substantially is filled into the chamber. The first sand particulates are arranged to the fluid in the chamber, and each of the first sand particulates has a specific gravity higher than the fluid, so that the first sand particulates can fall in the fluid upon inversion of the container. The second sand particulates are arranged to the fluid in the chamber, and each of the second sand particulates has a specific gravity lower than the fluid, so that the second sand particulates can rise in the fluid upon inversion of the container. The second sand particulates with a predetermined quantity fewer than the first sand particulates so as to provide slots which the first sand particulates can pass through gradually downwardly when the first sand particulates fall on and along a layer formed by the second sand particulates that rise upon inversion of the container in a vertical position. The container is substantially bubble-free.

### BRIEF DESCRIPTION OF THE DRAWINGS

FIG. 1 is a front view of a sand-flowing picture device according to prior art;

FIG. 2 is a front view of a sand-flowing picture device according to the present invention, showing a sand-flowing process;

FIG. 3 is a front view of a sand-flowing picture device according to the present invention, showing a sand-flowing picture;

FIG. 4 is a sectional view of the sand-flowing picture device according to the present invention; and

FIG. 5 is a perspective view of the sand-flowing picture device according to the present invention.

FIG. 6 is an exploded view of the sand-flowing picture device according to the present invention.

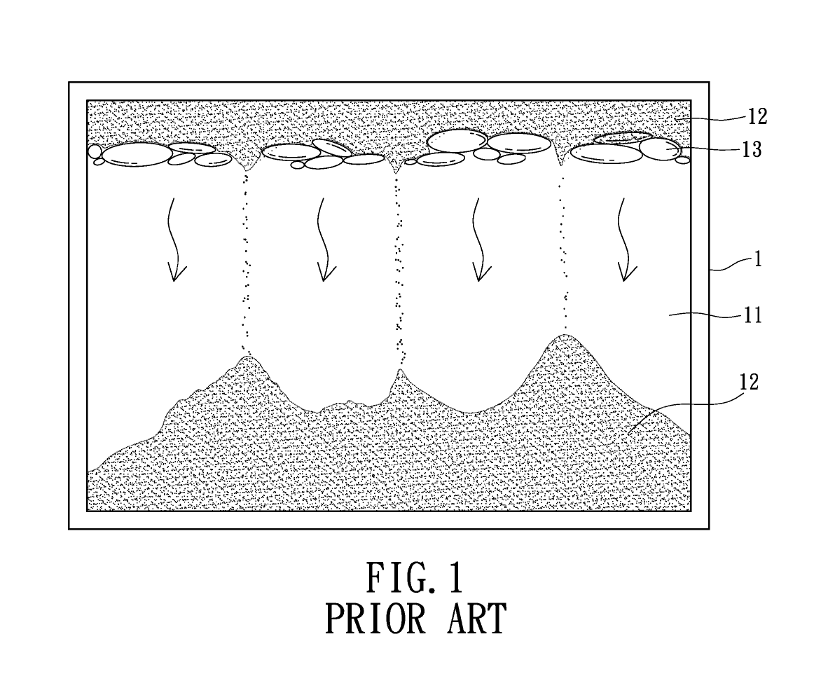

### DETAILED DESCRIPTION OF THE PREFERRED EMBODIMENT

Before the instant disclosure is described in greater detail in connection with the preferred embodiments, it should be noted that similar elements and structures are designated by like reference numerals throughout the entire disclosure.

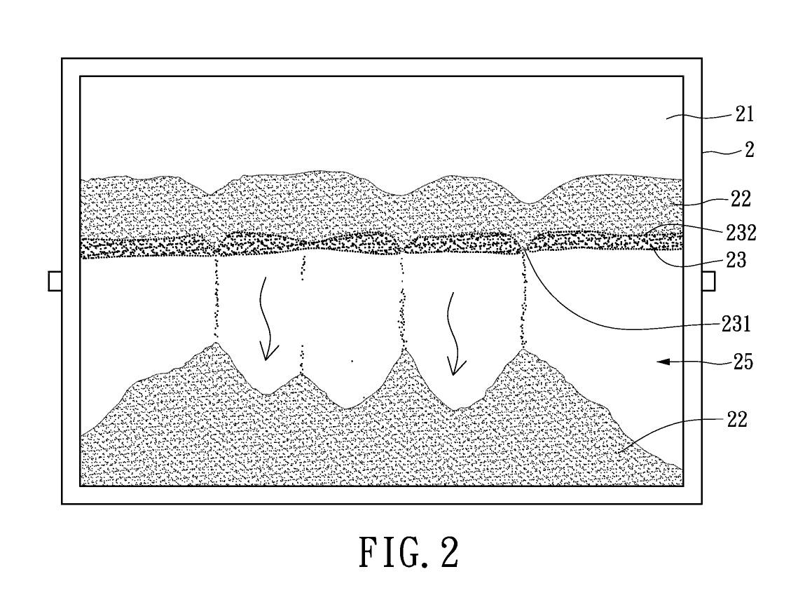

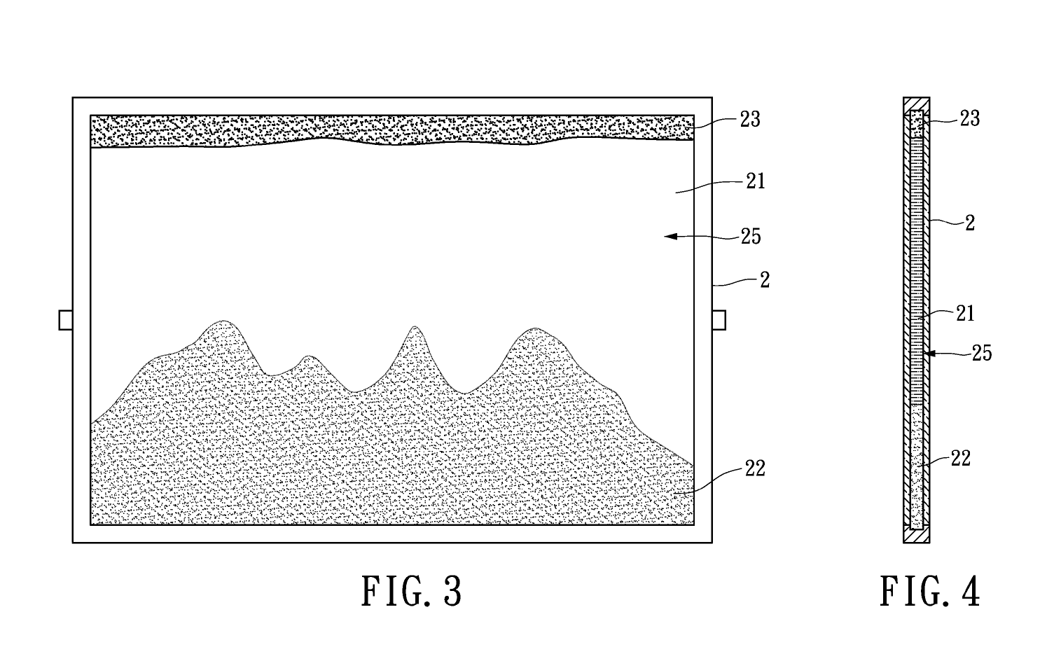

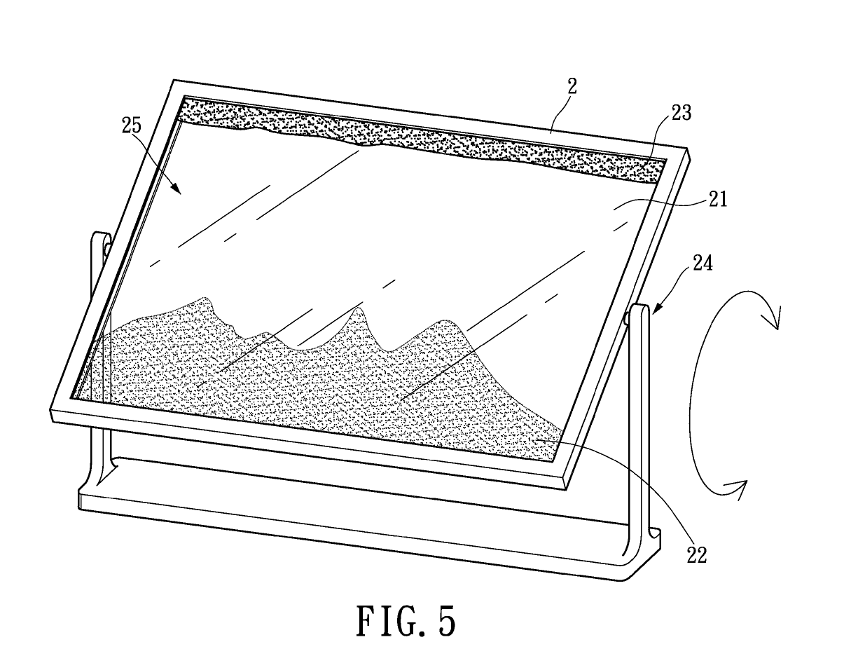

Referring to FIGS. 2-6, there is one embodiment of the present invention that discloses a sand-flowing picture device utilizing a sand-glass effect to show a picture of dynamic variation.

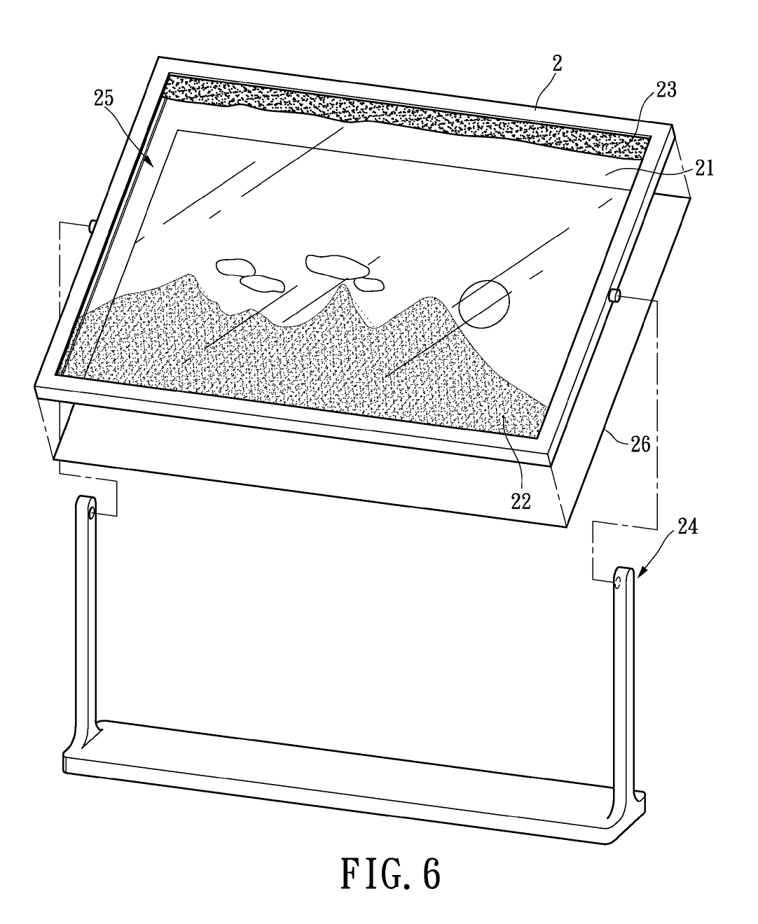

As shown in FIG. 6, the sand-flowing picture device includes a container 2, a fluid 21, a great quantity of first sand particulates 22, a small quantity of second sand particulates 23, a rack 24 and a background sheet 26.

The transparent, flat and sealed container 2 has two transparent glass sheets and two opposite frames combined together to outer edges of the two transparent sheets. The two transparent glass sheets are sealed and disposed in closely spaced to form a chamber 25, for viewing the chamber 25 through the transparent sheets. The container 2 can be a rectangle, triangle or round shape from a front view thereof.

The fluid 21 substantially is filled into the chamber 25 of the container 2 which no gas or air is inside. Therefore, the container 2 is substantially bubble-free. The fluid 21 can be water or oil, etc. It is to be understood that the container 2 has a filling hole (not shown), which is sealed after filling of the fluid 21, the first sand particulates 22 and the second sand particulates 23.

The first sand particulates 22 are arranged to the fluid in the chamber 25. Each of the first sand particulates 22 has a specific gravity (or a density) higher than the fluid 21, so that the first sand particulates 22 can fall in the fluid 21 upon inversion of the container 2. The first sand particulates 22 can be prepared in different colors and/or different sizes.

The second sand particulates 23 are arranged to the fluid 21 in the chamber 25. Each of the second sand particulates 23 has a specific gravity (or a density) lower than the fluid 21. For example, the specific gravity of the second sand particulate is between about 0.14 and 0.7, so that the second sand particulates 23 can rise in the fluid (the specific gravity of water is 1) upon inversion of the container 2.

In FIG. 2, the second sand particulates 23 with a predetermined quantity fewer than the first sand particulates 22 so as to provide slots 231 which the first sand particulates 22 can pass through gradually downwardly when the first sand particulates 22 fall on and along a layer 232 formed by the second sand particulates 23 that rise upon inversion of the container 2 in a vertical position. The second sand particulates 23 can be prepared in different colors and/or different sizes.

In addition, the second sand particulates 23 can be prepared from hollow glass microspheres, hollow ceramics particulates or combination thereof. The hollow glass microspheres each include an average particle size ranging from about 5 um to about 190 um. Also, the hollow ceramics particulates each include an average particle size ranging from about 90 um to about 300 um. Therefore, each of the second sand particulates 23 may have a size smaller than a bubble, thereby to obtain the better layer 232 formed by the second sand particulates 23 that rise to partially support first sand particulates 22 upon inversion of the container 2 in a vertical position for increasing the overall aesthetic feeling when viewing the container 2 during the sand-flowing process.

When the transparent, flat and sealed container 2 is turned upside down, the second sand particulates 23 float rapidly upwards in the fluid 21 and the first sand particulates 22 sink in the fluid 21 through slots 231 among the upwardly floating second sand particulates 23 subject to the effect that the second sand particulates 23 have more buoyancy than the fluid 21. During upward movement of the second sand particulates 23 and downward movement of the first sand particulates 22 in the fluid 21, a kind of picture of dynamic variation is seen. Finally, a large number of first sand particulates 22 sink to the bottom of the container; while a small number of second sand particulates 23 float to the top of container.

Further, the amount of the second sand particulates 23 must be properly controlled in the predetermined quantity. For example, the predetermined quantity of the second sand particulates 23 is approximately one tenth of the first sand particulates 22 from a front view of the container. If the amount of the second sand particulates 23 is excessively high, the second sand particulates 23 will prohibit the first sand particulates 22 from falling to the bottom in the fluid 21. If the amount of the second sand particulates 23 is excessively low, the first sand particulates 22 will fall to the bottom in the fluid 21 rapidly, the duration of the dynamic variation of the picture will be greatly shortened.

In addition, the rack 24 may be provided to support the transparent, flat and sealed container 2 for allowing the container 2 to be rotated relative to the rack 24. Also, the rack 24 can be designed for fitting the rectangular container, triangular container or round container. In addition, the background sheet 26 is arranged on a side of the container 2 or between the two glass sheets of the container 2 for producing a better visual effect in different patterns.

In another embodiment, the sand-flowing picture device includes a container, a fluid, a small quantity of first sand particulates, a large quantity of second sand particulates, a rack, and a background sheet.

Each of the first sand particulates has a specific gravity (or a density) higher than the fluid, so that the first sand particulates can fall in the fluid upon inversion of the container. The first sand particulates can be prepared in different colors and/or different sizes.

In addition, the second sand particulates are arranged to the fluid in the chamber. Each of the second sand particulates has a specific gravity (or a density) lower than the fluid, so that the second sand particulates can rise in the fluid (the specific gravity of water is 1) upon inversion of the container.

When the transparent, flat and sealed container is turned upside down, the large quantity of second sand particulates float upwards in the fluid, and the small quantity of first sand particulates sink rapidly in the fluid, so as to partially stop the upwardly floating second sand particulates subject to the effect that the second sand particulates have more buoyancy than the fluid. During the upward movement of the second sand particulates and downward movement of the first sand particulates in the fluid, a kind of picture of dynamic variation is seen. Finally, the small quantity of first sand particulates sink to the bottom of the container, and the large quantity of second sand particulates float to the top of container.

Therefore, the present invention could not only eliminate the shortcomings existing in the prior art of the sand-flowing picture device, but also provide following unexpected results and advantages:

1. The present invention uses sand particulates with a specific gravity lower than the fluid to substitute for bubbles, so as to easily control the quantity of the sand particulates. However, the prior art needs to use a bubble producing substance for producing a large number of bubbles.

2. The present invention uses sand particulates with a specific gravity lower than the fluid to substitute for bubbles, thus the quantity sand particulates (solid) is fixed and not reduced or disappeared. However, the bubbles (air or gas) of the prior art will gradually decrease and then disappear, or gradually increase.

3. The present invention uses sand particulates with a specific gravity lower than the fluid to substitute for bubbles, thereby to increase the aesthetic feeling with all sand particulates flowing in the container. However, the scene in which the bubbles with different sizes of the prior art are mixed with the sand particulates is not attractive.

4. The present invention uses sand particulates with a specific gravity lower than the fluid to substitute for bubbles, thereby to maintain the better effect of the multi-layer picture pattern for a long time. However, once the bubbles of the prior art disappeared, the multi-layer picture pattern will also disappear subsequently.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A sand-flowing picture device, comprising:
a transparent, flat and sealed container having a chamber formed therein;
a fluid substantially filled into the chamber;
a large quantity of first sand particulates arranged to the fluid in the chamber, each of the first sand particulates having a specific gravity higher than the fluid, so that the first sand particulates can fall in the fluid upon inversion of the container; and
a small quantity of second sand particulates arranged to the fluid in the chamber, each of the second sand particulates having a specific gravity lower than the fluid, so that the second sand particulates can rise in the fluid upon inversion of the container;
wherein the second sand particulates with a predetermined quantity fewer than the first sand particulates so as to provide slots which the first sand particulates can pass through gradually downwardly when the first sand particulates fall on and along a layer formed by the second sand particulates that rise upon inversion of the container in a vertical position;
wherein the container is substantially bubble-free.

2. The sand-flowing picture device as claimed in claim 1, wherein the second sand particulates are hollow glass microspheres, hollow ceramics particulates or combination thereof.

3. The sand-flowing picture device as claimed in claim 2, wherein the hollow glass microspheres each include an average particle size ranging from about 5 um to about 190 um, and the hollow ceramics particulates each include an average particle size ranging from about 90 um to about 300 um.

4. The sand-flowing picture device as claimed in claim 1, wherein the specific gravity of the second sand particulate is between about 0.14 and 0.7.

5. The sand-flowing picture device as claimed in claim 1, further comprising a rack supporting the container for allowing the container to be inverted relative to the rack.

6. The sand-flowing picture device as claimed in claim 1, further comprising a background sheet arranged on a side of the container.

7. The sand-flowing picture device as claimed in claim 1, wherein the first sand particulates have different colors.

8. The flowing sand picture as claimed in claim 1, wherein the second sand particulates have different colors.

9. A sand-flowing picture device, comprising:
a transparent, flat and sealed container having a chamber formed therein;
a fluid substantially filled into the chamber;
first sand particulates arranged to the fluid in the chamber, each of the first sand particulates having a specific gravity higher than the fluid, so that the first sand particulates can fall in the fluid upon inversion of the container; and
second sand particulates arranged to the fluid in the chamber, each of the second sand particulates having a specific gravity lower than the fluid, so that the second sand particulates can rise in the fluid upon inversion of the container;
wherein the second sand particulates with a predetermined quantity fewer than the first sand particulates so as to provide slots which the first sand particulates can pass through gradually downwardly when the first sand particulates fall on and along a layer formed by the second sand particulates that rise upon inversion of the container in a vertical position.

10. The sand-flowing picture device as claimed in claim 9, wherein the predetermined quantity of the second sand particulates is approximately one tenth of the first sand particulates from a front view of the container.

11. A sand-flowing picture device, comprising:
a transparent, flat and sealed container having a chamber formed therein;
a fluid substantially filled into the chamber;
first sand particulates arranged to the fluid in the chamber, each of the first sand particulates having a specific gravity higher than the fluid; and
second sand particulates arranged to the fluid in the chamber, each of the second sand particulates having a specific gravity lower than the fluid;
wherein the container is substantially bubble-free.

12. The sand-flowing picture device as claimed in claim 11, wherein the first sand particulates with a predetermined quantity fewer than the second sand particulates.

13. The sand-flowing picture device as claimed in claim 12, wherein the predetermined quantity of the first sand particulates is approximately one tenth of the second sand particulates from a front view of the container.

14. The sand-flowing picture device as claimed in claim 11, wherein the second sand particulates with a predetermined quantity fewer than the first sand particulates.

15. The sand-flowing picture device as claimed in claim 14, wherein the predetermined quantity of the second sand particulates is approximately one tenth of the first sand particulates from a front view of the container.
